(19) United States
(12) Patent Application Publication
(10) Pub. No.: US 2015/0231855 A1
(43) Pub. Date: Aug. 20, 2015

(54) CARBON FIBER FABRIC AND PROCESS FOR ITS MANUFACTURE

(71) Applicant: Automobili Lamborghini S.p.A, Sant'Agata Bolognese BO (IT)

(72) Inventor: Attilio Masini, Monteveglio BO (IT)

(21) Appl. No.: 14/365,206

(22) PCT Filed: Feb. 11, 2013
(86) PCT No.: PCT/IB2013/051112

§ 371 Date: Jun. 13, 2014

(30) Foreign Application Priority Data
Feb. 20, 2012 (IT) MI2012A000244

(51) Int. Cl. B32B 5/02; B29C 65/48; B32B 27/12; B29C 65/44; B32B 27/40; B32B 27/30

(52) U.S. Cl. CPC B32B 5/024; B32B 5/022; B32B 27/40; B32B 27/308; B32B 27/12; B29C 65/44; B29C 65/48; B32B 2260/021; B32B 2260/046; B32B 2262/106; B32B 2437/00; B29L 2031/726

(57) ABSTRACT

Woven carbon fiber, in which a polyurethane film or acrylic is joined to at least one side of this fabric. The present invention also relates to a process for the manufacture of such fabric, as well as a product of clothing or leather goods comprising this fabric.

The present invention relates to a fabric made of carbon fiber, in particular a flexible fabric that can be used for products of clothing or leather goods. The present invention also relates to a process for the manufacture of such fabric, as well as a product of clothing or leather goods comprising this fabric.

Known carbon fiber fabrics comprise a web of thin filaments of carbon fibers arranged perpendicularly to each other. These known fabrics are impregnated with polymeric resins and overlapped according to suitable directions. The resins are cured to obtain rigid materials with a high specific resistance, which are suitable for the production of structural parts or aesthetic parts. These materials, because of their characteristic stiffness, cannot be applied for example to the clothing industry, where flexible fabrics that can be sewn and folded are required. This also excludes the use of raw fabrics made of carbon fiber, which tend to unthread and are not able to keep unchanged the arrangement of the fibers once deformed.

JP-A-2003245991 and US-A-2008023010 disclose garments comprising a carbon fiber fabric laminated with a polymeric layer, in particular polyurethane.

JP-A-20011162897 discloses a carbon fiber fabric for bags or garments, which is impregnated with an acrylic or polyurethane resin.

The object of the present invention is therefore to provide a fabric made of carbon fiber free from said drawbacks. Said object is achieved with a fabric, a process and a product, whose main features are specified in claims 1, 2 and 12, while other features are specified in the remaining claims.

Thanks to its particular features, the fabric according to the present invention can be advantageously used for products and accessories of clothing or leather goods, in particular bags, as well as for other applications requiring a flexible fabric, such as for example coatings of seating and interior walls, in particular of motor vehicles. In fact, the fabric according to the present invention does not fray even when the fibers are stressed by the seams. Furthermore, even if deformed, the fabric maintains a substantially perpendicular arrangement and a limited longitudinal sliding of the fibers, so as to avoid permanent deformations of its structure.

A particular protective layer is preferably applied to the fabric to improve the handling during the manufacture and/or to limit the flexibility of the fabric, as well as to make it resistant, waterproof, insulating, semi-transparent, non-transparent and/or opaque.

The fabric according to the present invention is pleasant to the touch and has a high resistance, superior to that of a raw fabric of carbon fiber, while retaining an extreme flexibility which allows also to create folds or hems on the same fabric without compromising the integrity. The fabric is also very elastic since the particular layers applied to it ensure a correct arrangement of the texture even after deformations. It is therefore possible to deform this fabric without compromising its texture and without causing unthreadings between the fibers.

According to an aspect of the invention, the particular polyurethane or acrylic film adheres only to the most superficial fibers of the fabric of carbon fiber, while the filaments in the most inner layers of the fabric remain free to slide between them, so as to obtain a fabric resistant to surface wear, but still extremely flexible.

At least one edge of the fabric in its final configuration is preferably folded and sewn on itself, so as to form a hem that prevents unthreading of the fibers of the most inner layers of the fabric.

Further advantages and characteristics of the fabric and of the process according to the present invention will become apparent to those skilled in the art from the following detailed and non-limiting description of an embodiment thereof with reference to the accompanying drawings in which:

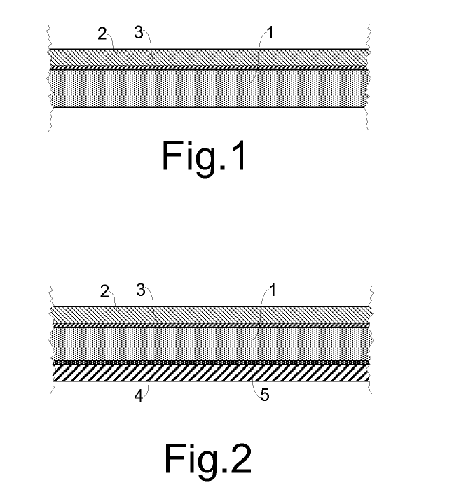

FIG. 1 shows a partial section of the fabric during a step of the process; and

FIG. 2 shows the fabric of FIG. 1 during a subsequent step of the process.

Referring to FIG. 1, it is seen that fabric 1 according to the present invention comprises at least a weave, in particular cloth, twill or satin weave, of yarns of carbon fiber having a linear density between 50 and 5000 g/km and comprising from 1000 to 60000 filaments, in particular from 3000 to 24000 filaments having a diameter comprised between 5 and 10 microns. The thickness of fabric 1 is comprised between 50 and 1000 microns.

In a first preliminary operating step, to ensure the regularity and a good aesthetic finish of the weave, fabric 1 is brushed and/or ironed at a temperature comprised between 30° and 200° and/or at a pressure comprised between 10 and 200 bar by means of two cylinders or two plates suitable to exert a variable pressure.

In a second preliminary operating step, at least one protective layer 2, in particular comprising a film or a nonwoven fabric made of polyester, polyamide or glass fiber, is applied onto one side of fabric 1 by means of at least one adhesive layer 3, in particular based on polyurethane, acrylic or silicone, applied to fabric 1. The thickness of the protective layer 2 is comprised between 50 and 500 microns. During the application of the protective layer 2 to fabric 1 the adhesive layer 3 is heated to a temperature comprised between 50° and 250°, so as to melt the adhesive layer 3 without changing the features of the protective layer 2.

Referring to FIG. 2, it is seen that in a main operating step a polyurethane or acrylic film 4, preferably transparent or semi-transparent, is applied onto the opposite side of fabric 1 with respect to the protective layer 2, namely fabric 1 is comprised between the protective layer 2 and the polyurethane or acrylic film 4. The polyurethane or acrylic film 4 has a thickness comprised between 50 and 500 microns and is applied to fabric 1 by means of a lamination, in particular a hot calendering or pressing, in which fabric 1 and the polyurethane or acrylic film 4 are laminated together at a temperature comprised between 30° and 200° and/or at a pressure comprised between 10 and 200 bar. During this operating step the surface of the polyurethane or acrylic film 4 in contact with fabric 1 partially penetrates fabric 1, so as to create an intermediate layer 5, having a thickness comprised between 5% and 60% of the thickness of fabric 1, wherein the outer filaments of fabric 1 are integral with the polyurethane or acrylic film 4.

In an alternative embodiment, the polyurethane or acrylic film 4 can be applied to fabric 1 in the described above manner before applying the protective layer 2.

In a final operating step, at least one edge of fabric 1 joined to the polyurethane or acrylic film 4 and to the protective layer 2, if any, is folded and sewn on itself so as to form a hem.

Possible variants and/or additions may be made by those skilled in the art to the embodiment of the invention here described and illustrated remaining within the scope of the following claims. In particular, further embodiments of the invention may include the technical features of one of the following claims, with the addition of one or more technical features, taken individually or in any mutual combination, described in the text and/or illustrated in the drawings.

1. Carbon fiber fabric, wherein a polyurethane or acrylic film is laminated to at least one side of this fabric and partially penetrates the fabric, so as to create an intermediate layer in which the outer filaments of the fabric are integral with the polyurethane or acrylic film.

2. Process for manufacturing carbon fiber fabrics, wherein a polyurethane or acrylic film is applied to one side of a carbon fiber fabric by means of lamination, in particular a hot calendering or pressing, in which the surface of the polyurethane or acrylic film contacting the fabric partially penetrates the fabric to create an intermediate layer in which the outer filaments of the fabric are integral with the polyurethane or acrylic film.

3. Process according to claim 1 the previous claim, wherein said lamination is carried out at a temperature comprised between 30° and 200° and/or at a pressure between 10 and 200 bar.

4. Fabric according to claim 1, wherein the fabric comprises a weave, of yarns of carbon fiber having a linear density between 50 and 5000 g/km and comprising from 1000 to 60000 filaments.

5. Fabric according to claim 1, wherein the side of the fabric opposite to the polyurethane or acrylic film is joined to a protective layer, so that the fabric is comprised between the protective layer and the polyurethane or acrylic film.

6. Process according to claim 1, wherein the protective layer is applied to the fabric before applying the polyurethane or acrylic film to the fabric.

7. Fabric according to claim 5, wherein the protective layer comprises a film or a nonwoven fabric and is made of polyester, polyamide or fiberglass.

8. Fabric according to claim 5, wherein the protective layer is applied to a side of the fabric by means of at least one adhesive layer.

9. Fabric according to claim 1, wherein at least one edge of the fabric joined to the polyurethane or acrylic film and to the protective layer, if any, is folded and sewn on itself so as to form a hem.

10. Fabric according to claim 1, wherein the thickness of the intermediate layer is between 5% and 60% of the thickness of the fabric.

11. Fabric according to claim 1, wherein the polyurethane or acrylic film is transparent or semitransparent.

12. Clothing or leather goods product, in particular a bag, it comprises a fabric according to claim 1.

13. Fabric according to claim 4, wherein the weave is a cloth, twill or satin weave.

14. Fabric according to claim 4, wherein the weave comprises from 3000 to 24000 filaments having diameter between 5 and 10 microns.
